(19) United States
(12) Patent Application Publication
(10) Pub. No.: US 2010/0313463 A1
(43) Pub. Date: Dec. 16, 2010

(54) Stinger Spinner Jig

(76) Inventor: Robert Coxey, Jacksonville, FL (US)

Correspondence Address: Matthew Davies IPRC, 13870 Devan Lee Drive North, Jacksonville, FL, 32226, US

(21) Appl. No.: 12/612,074

(22) Filed: Nov. 4, 2009

Related U.S. Application Data
(60) Provisional application No. 61/186,105, filed on Jun. 11, 2009.

(51) Int. Cl. A01K 85/10; A01K 85/00

(52) U.S. Cl. 43/42.39; 43/42.37; 43/42.11; 43/42.13; 43/44.8

(57) ABSTRACT

This stinger-spinner jig will allow the artificial bait that is on the hook to remain in the area of the fish or strike zone as long as possible and better mimic the action of a wounded baitfish. This in turn will make the device a more effective type of lure. This desired effect is made possible because of a specific design of the straight or angled piece of metal wire from the body of the lure and the use of a spinner blade to create additional lift.

### CROSS-REFERENCES

The present application claims the benefit of the Provisional Application No. 61/186,105 filed Jun. 11, 2009.

### GOVERNMENT RIGHTS

None

### OTHER PUBLICATIONS

None

### BACKGROUND OF INVENTION

1. Field of Invention

This relates to fishing in general and the specific action produced by a variety of hooks. In order to obtain the best fishing, the bait that is secured to the hook must remain in what is generally known as the “strike zone”, which is the area that is referred to as having the greatest concentration of fish at any particular time. The longer the bait remains in the strike zone the higher the probability a fish will grab the bait. Additionally, the more the hook and bait act like true bait, the greater the chance a fish will be attracted.

2. Discussion

There are many other prior art references to hooks, lines, and fishing equipment. This application involves a modification to an existing hook, which is not found in the prior art. A representative example in the prior art includes Gentry, U.S. Pat. No. 4,901,470, Gorney, U.S. Pat. No. 5,647,163, and Martinez, U.S. Pat. No. 5,412,901.

The Gentry device has a piece of metal attached to the body of the lure near the junction of the line and the lure. However, the Gentry device is different in that the bait is placed on the same side as the blade. This may, in fact, create entanglement problems with the existing bait, which is corrected by the lure device. Additionally, the Gentry application is not angled its finger. This is important in creating the action for the bait to breakdown as far as maintaining its position in the strike zone.

### SUMMARY OF INVENTION

This is a fishing device and, more specifically, a specifically designed hook that will attract fish. The device is an artificial lure with a hook, a body and a spinner blade that is attached to the fishing rod.

As a general rule, in order to catch fish, the bait must remain in an area that is commonly referred to as a “strike zone”. The strike zone is the area of largest concentration of fish and may change from time to time depending on the conditions of the lake, stream, river, or any other body of water.

As any artificial lure moves through the water, the action or movement of the lure attracts fish in certain ways.

The first way that fish are attracted to the lure is a vibratory effect in the water that is created by the artificial lure. Most lures create this vibration by use of what is commonly referred to as a spinner blade or blades if more than one is used. Secondly while in the water the blades' reflection is noticed by the fish while the lure moves through the water. Ideally the final way that fish are attracted is by the lure imitating the movement of wounded bait by moving up and down within the strike zone for the longest possible time.

This device uses a standard hook and a stinger which is a small piece of wire that is attached to the hook by a lead jig head. It is straight or angled off the opposite side of the hook from the barb. A blade creates a flash effect and is also attached to the stinger wire to create the appropriate reflective and vibrating action.

Unlike some of the prior art the stinger and blade are placed on the opposite side of the hook shank from the barb. The particular placement is what makes it so unique and effective and gives it extra lift during retrieval and extra drag while falling.

### BRIEF DESCRIPTION OF DRAWINGS

FIG. 1 is a front view of the device depicting multiple blades.

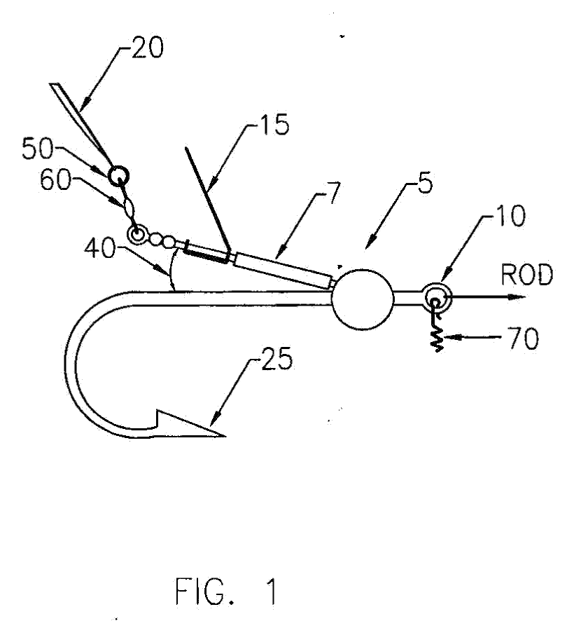

FIG. 2 is a front view of the device depicting a single blade.

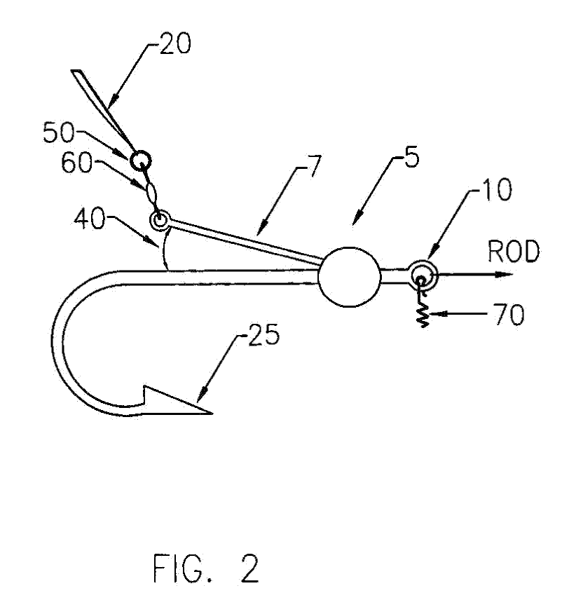

FIG. 3a is a view of the hook with a single in-line spinner blade.

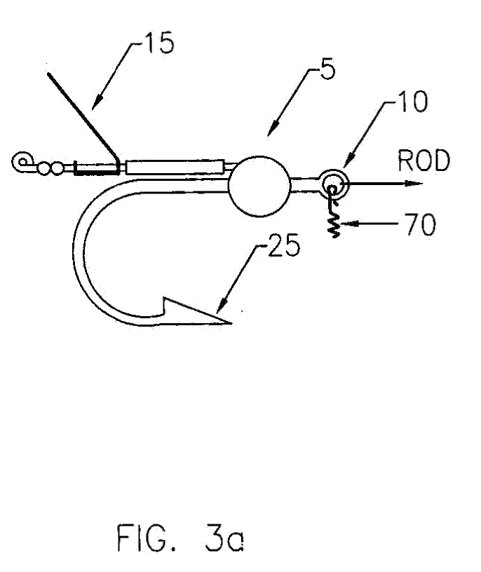

FIG. 3b is a view of the hook with a single standard spinner blade.

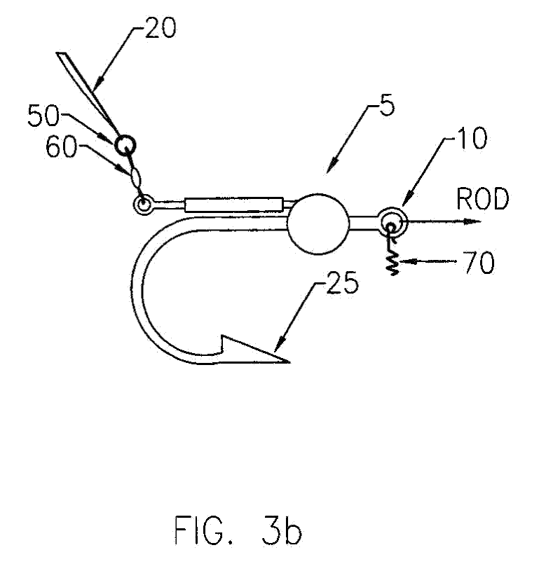

FIG. 4 is a view of the fully assembled device depending on choice of a spinner blade, a hook, a jig head and plastic bait.

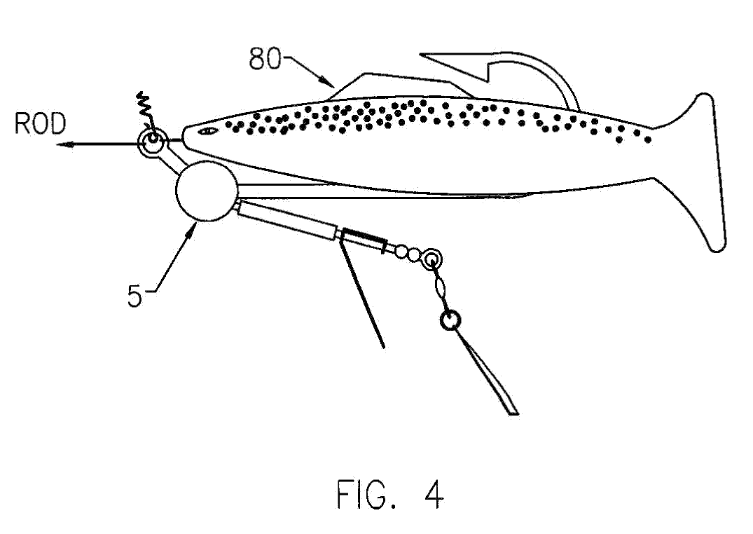

FIG. 5 is a depiction of the device attached to a rod.

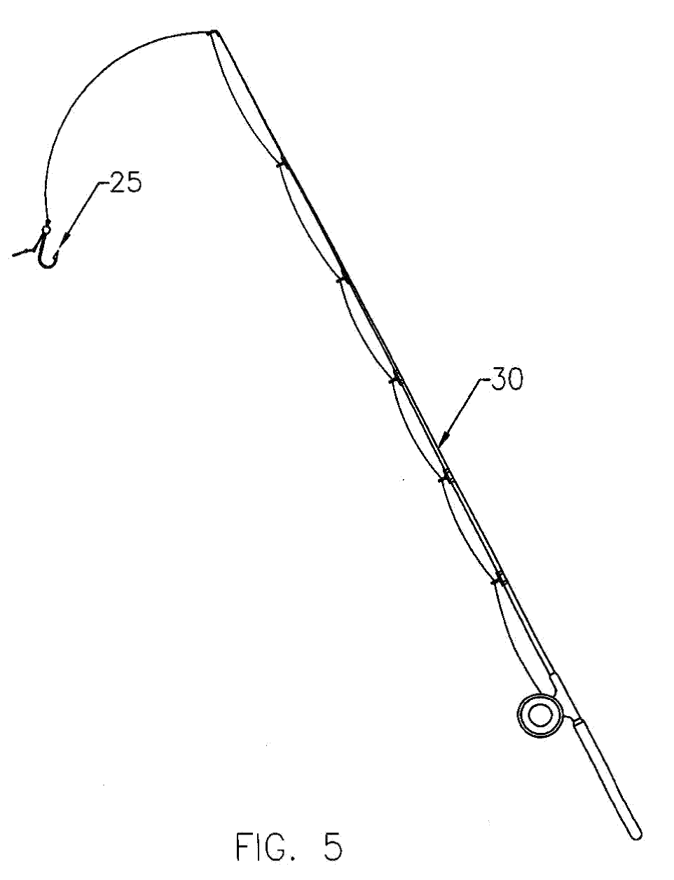

FIG. 6 is a depiction of the device in use.

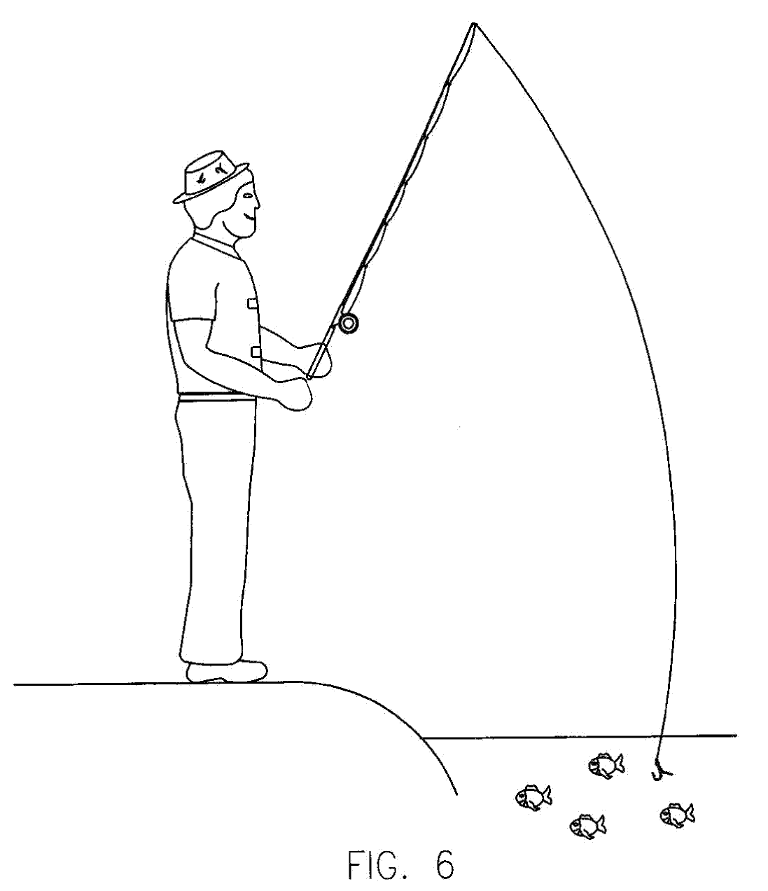

### DETAILED DESCRIPTION OF THE INVENTION

This is a spinner bait type fishing lure or jig 1. Because of its unique design, it will provide all of the benefits of a standard fishing lure but will improve the performance of the standard lure by adding additional lift during retrieval and more resistance to the effects of gravity when allowed to fall.

Any lure needs to perform three different functions in order to be the most effective artificial bait while fishing. A lure must create a vibratory effect as it moves through the water. It must also create a certain amount of flash by use of a reflective material. The lure must also mimic live bait while remaining in the “strike zone” for as long as possible. If the lure does not perform these three functions, it remains less effective as a lure.

This device will create both the desired reflective and vibratory effects as it moves through the water by the use of a spinner blade attached to the spinner wire. More than one blade may be used.

The improvement of this device is that it mimics baitfish by falling more slowly and remains in the strike zone longer than most lures because of the unique design. The strike zone is the area, which has a greater concentration of fish than other areas in a lake, stream, pond or any other body of water.

The jig will consist of a hook 10, which is in the normal shape of a hook. One end of the artificial bait is placed on the barbed end 25 of the hook and the other is attached to the eye by use of a coiled piece of wire 70. One end of the hook 10 will be attached to the line, which goes to the rod 30 and reel. This device can be used with any type rod 30 and reel so no specific rod 30 and reel combination is being claimed.

On the bottom surface of the hook 10 along the shank (straight) portion of the hook will be a piece of wire that is attached to the hook by use of a piece of lead 5 that is called a jig head. A piece of straight metal 7, called a stinger wire member, will create an angle 40 between 0° and 60° from the shank of the hook. This angling will produce the desired effect while in the strike zone because it forces the lure to move more in an up and down direction while in the strike zone as opposed to moving laterally through the strike zone as is typical of most lures.

Attached to the metal piece of wire 7 will be what is commonly referred to as a spinner blade that will produce the reflective and vibratory effect. The spinner blade may be either an in-line spinner blade 15 or a standard spinner blade 20. This standard spinner blade 20 will be allowed to move freely while attached to the piece of wire 7 that is angled from the lure by use of a split ring 50 and a swivel 60. The in-line spinner blade 15 is allowed to freely rotate axially around the metal wire 7. With this device more than one blade may be used.

As the bait and the hook 10 are cast into the strike zone, it will move very slowly downward towards the bottom due to the placement and resistance of the spinner blade which is more consistent with the action wounded baitfish. Other types of lures will not move slowly in an up and down direction while in the strike zone because of the lack of resistance to gravity while falling. The position and angling of the stinger wire with the attached blade creates more lift when retrieving.

Additionally, when the rod and reel is twitched or jerked and because of the design of the device, the jig will tend to move more vertically due to the lift created by the position of the spinner blade and stay in the strike zone longer.

The invention claimed is:

1. A Stinger spinner jig apparatus comprising:
a jig body being a weighted portion having a leading edge and a trailing edge;
a hook having an eyelet, a shank having a bend terminating in a pointed end, said pointed end having a barb and facing the leading edge of the jig;
a coiled wire connected to said hook eyelet;
a wire support member having a leading edge and a trailing edge;
at least one spinner blade;
wherein said hook shank and said leading edge of said wire support member are embedded within said jig body such that said wire support protrudes from said trailing edge of said jig body at an acute angle.

2. The apparatus of claim 1, wherein said wire support member faces the trailing edge of said jig.

3. The apparatus of claim 1, wherein said wire support member extends the length of the shank.

4. The apparatus of claim 1, wherein said acute angle of embedded wire may be at an angle of 0° to 60° from the shank axis.

5. The apparatus of claim 1, wherein said trailing edge of said wire support member is connected to said spinner blade.

6. The apparatus of claim 1, wherein said at least one spinner blade may be in-line, standard, or both.

7. The apparatus of claim 1, wherein said trailing edge of said wire support member is connected to said standard spinner blade via a split ring and swivel.

8. The apparatus of claim 1, wherein said in-line spinner blade is attached and allowed to rotate freely around said trailing edge of said wire support.

9. The apparatus of claim 1, wherein said weighted portion may be of any size or shape.

10. A Stinger spinner jig apparatus comprising:
a jig body being a weighted portion having a leading edge and a trailing edge;
a hook having an eyelet, a shank having a bend terminating in a pointed end, said pointed end having a barb and facing the leading edge of the jig;
a coiled wire connected to said hook eyelet;
a wire support member having a leading edge and a trailing edge;
at least one spinner blade;
wherein said embedded wire faces the trailing edge of the jig;
wherein said spinner blade may be connected to said trailing edge wire support member either directly or via a split ring and swivel such that they are permitted to freely rotate;
wherein said hook shank and said leading edge of said wire support member are embedded within said jig body such that said wire support protrudes from said trailing edge of said jig body at an acute angle.

11. The apparatus of claim 10, wherein said acute angle of embedded wire may be placed at an angle of 0° to 60° from the shank axis.

12. The apparatus of claim 10, wherein said at least one spinner blade may be in-line, standard or both.

13. The apparatus of claim 10, wherein said trailing edge of said wire support member is connected to said standard spinner blade via a split ring and swivel.

14. The apparatus of claim 10, wherein said in-line spinner blade is attached and allowed to rotate freely around said wire support.

15. A Stinger spinner jig apparatus comprising:
a jig body being a weighted portion having a leading edge and a trailing edge;
a hook having an eyelet, a shank having a bend terminating in a pointed end, said pointed end having a barb and facing said leading edge of the jig;
a coiled wire connected to said hook eyelet;
a wire support member extending the length of said shank and having a leading edge and a trailing edge;
one or more spinner blades;
wherein said embedded wire support member faces the trailing edge of said jig and is placed at an angle of 0° to 60° from the shank axis;
wherein said one or more spinner blades may be connected to the trailing edge wire support member either directly or via a split ring and swivel such that they are permitted to rotate freely;
wherein said one or more spinner blades may be of the in-line type, standard type, or both;
wherein said hook shank and said leading edge of said wire support member are embedded within said jig body such that said wire support protrudes from said trailing edge of said jig body.
